(19) United States
(12) Patent Application Publication
(10) Pub. No.: US 2015/0068081 A1
(43) Pub. Date: Mar. 12, 2015

(54) INTERNALLY ILLUMINATED SIGN DEVICE

(71) Applicant: NIPPON CARBIDE INDUSTRIES, CO., INC., Tokyo (JP)

(72) Inventors: Ikuo Mimura, Uozu-shi (JP); Masatoshi Sanagawa, Tokyo (JP)

(21) Appl. No.: 14/482,546

(22) Filed: Sep. 10, 2014

(30) Foreign Application Priority Data
Sep. 12, 2013 (JP) 2013-189884

(51) Int. Cl. G09F 19/20; G09F 13/04

(52) U.S. Cl. CPC G09F 19/20; G09F 13/04; G09F 13/0413
USPC 40/564

(57) ABSTRACT

An internally illuminated sign device according to an embodiment includes a sign panel and a lighting unit that applies light from the rear side to the sign panel. The sign panel includes a prism layer, an air layer disposed on an interface on the rear side of the prism layer, a first colored display layer of optical transparency disposed on the front side of the prism layer and having a predetermined shape, and a second colored display layer of optical transparency disposed on the rear side of the air layer in a shape visible the same as the first colored display layer. The second colored display layer is disposed at a position laid over the first colored display layer when the sign panel is seen in front.

### BACKGROUND OF THE INVENTION

The present invention relates to an internally illuminated sign device that is preferred to the case where visibility is improved, and more particularly to the case where the hues of a recognized sign are made the same between the daytime and the nighttime.

Heretofore, an internally illuminated sign device is proposed in which a sign panel is provided on the opening of a housing and a lighting unit is internally provided in the housing located on the rear side of the sign panel (e.g., see Patent Literature 1).

The sign panel has a structure in which a colored display layer expressing information is disposed on the front face of the panel, and a retroreflective layer is disposed on the rear side of the colored display layer.

According to such an internally illuminated sign device, in the daytime, natural light from the outside of the housing is mainly diffusely reflected on the front face of the sign panel, and then information on the colored display layer is visually recognized.

Moreover, in the nighttime, light from the lighting unit in the housing is transmitted through the colored display layer of the sign panel, and light from the outside of the housing such as the headlight of an automobile is retroreflected in the retroreflective layer and the light is transmitted through the colored display layer, and then information on the colored display layer is visually recognized.

Furthermore, in an emergency in which in the nighttime, it is not enabled to apply light from the rear side to the sign panel because the lighting unit is broken, for example, light entered from the outside of the housing to the colored display layer of the sign panel and retroreflected in the retroreflective layer is transmitted through the colored display layer, and then information on the colored display layer is visually recognized.
[Patent Literature 1] WO2004/006216 A1

### SUMMARY OF THE INVENTION

In such an internally illuminated sign device, in order to improve the conspicuity of the sign in the nighttime, the illuminance of light from the lighting unit is enhanced to increase the amount of light transmission.

However, such tendencies are revealed that when the illuminance of light from the lighting unit is increased, the lightness of the colored display layer is increased, and the contrast ratio of the colored display layer portion to portions other than the colored display layer is reduced, causing the degradation of visibility on the contrary, or causing the difference between hues of the information display portions expressed in the colored display layer in the nighttime and hues in the daytime, which is resulted in a functionally useless sign.

For a method for suppressing a reduction in the contrast ratio, it is considered to increase the thickness of the colored display layer of the sign panel. However, when the thickness of the colored display layer is increased, the amount of light is reduced which is transmitted through the colored display layer, retroreflected in the retroreflective layer, and transmitted through the colored display layer in the amount of light entered from the outside of the housing. Therefore, it is revealed that the retroreflection performance of the colored display layer portion is degraded and the sign is functionally useless in an emergency in which it is not enabled to apply light to the sign panel from the inside in the nighttime.

Therefore, the present invention is to provide an internally illuminated sign device that can further improve visibility.

In order to solve the above-described problem, according to the present invention, an internally illuminated sign device comprising: a sign panel; and a lighting unit configured to apply light from a rear side of the sign panel to the sign panel, wherein the sign panel includes a prism layer, an air layer disposed on an interface on a rear side of the prism layer, a first colored display layer of optical transparency disposed on a front side of the prism layer, the first colored display layer having a predetermined shape, a second colored display layer of optical transparency disposed on a rear side of the air layer, the second colored display layer having a shape visible similarly to the first colored display layer, and the second colored display layer is disposed at a position at which the second colored display layer is overlapped with the first colored display layer when the sign panel is seen in front.

In the case where light is applied from the lighting unit that is provided in the inside and located on the rear side to the sign panel, the amount of light transmitted through the second colored display layer and the first colored display layer and emitted from the sign panel is smaller than the amount of light that is not transmitted through the colored display layer and is emitted from the sign panel.

Therefore, the contrast ratio between the information display portion expressed on the colored display layer and the portions other than the information display portion is greater, as compared with the case where the sign panel includes only the first colored display layer.

Thus, it is possible to improve the visibility of the sign, as compared with the case where only the first colored display layer is included when light is applied from the rear side (from the inside) to the sign panel in the nighttime.

On the other hand, the most part of light entered from the front face of the sign panel is retroreflected in the interface between the prism layer and the air layer, which is the retroreflective plane, and there is little light that passes through the interface and further goes to the rear side. In the first colored display layer and the second colored display layer, the colored display layer through which light entered from the front face of the sign panel is transmitted is only the first colored display layer disposed in front of the prism layer more or less.

Therefore, even though both of the first colored display layer and the second colored display layer are provided, it is possible to suppress the degradation of the retroreflection performance of the information display portion expressed on the colored display layer.

Thus, the retroreflection performance is not degraded, so that it is possible to provide a functionally useful sign in an emergency in which light is not enabled to be applied from the inside to the sign panel in the nighttime.

As described above, in the sign panel according to an aspect of the present invention, a most part of retroreflected light is transmitted only through the first colored display layer, and interior luminous light is transmitted through both of the first colored display layer and the second colored display layer. Thus, it is possible to improve the visibility in the case where light is applied from the inside to the sign panel in the nighttime with no degradation of the retroreflection performance of the colored display layer portion. Accordingly, it is to provide an internally illuminated sign device that can further improve visibility.

Further, it is preferable that an amount of light transmission in the first colored display layer is greater than an amount of light transmission in the second colored display layer.

In the case where this configuration is provided, the amount of light transmitted through the first colored display layer is hardly reduced, so that it is possible to improve the retroreflection performance of the colored display layer portion. Accordingly, it is possible to improve the visibility of the sign illuminated with retroreflected light in an emergency in the nighttime as described above.

Further, it is preferable that a size of the second colored display layer is smaller than a size of the first colored display layer when the sign panel is seen in the front.

In the case where this configuration is provided, it is possible to reduce the amount of light that spreads in the second colored display layer and goes to avoid the first colored display layer, as compared with the case where the size of the second colored display layer is greater than the size of the first colored display layer. Accordingly, it is possible to further improve the visibility of the sign illuminated with interior luminous light.

Moreover, preferably, a layer disposed between the first colored display layer and the second colored display layer is not colored.

As described above, in the case where a layer disposed between the first colored display layer and the second colored display layer is not colored, it is possible to easily control the hue and lightness of the information display portion expressed on the colored display layer by interior luminous light, as compared with the case where a layer disposed between the first colored display layer and the second colored display layer is colored.

Furthermore, preferably, the first colored display layer and the second colored display layer are colored in a same hue.

When colors are applied to the first colored display layer and the second colored display layer to have almost the same hues, the hues of the information display portion in the daytime can be made almost the same as the hues of the information display portion in the nighttime. Accordingly, it is possible to improve the visibility of the sign illuminated with interior luminous light in the nighttime as the hues of the recognized sign are kept almost the same between the daytime and the nighttime.

As described above, according to an aspect of the present invention, it is possible to provide an internally illuminated sign device that can further improve visibility. Moreover, it is possible to provide an internally illuminated sign device that can make the hues of the recognized sign the same between the daytime and the nighttime.

### BRIEF DESCRIPTION OF THE DRAWINGS

FIG. 1 is a diagram of an internally illuminated sign device according to a first embodiment;

FIG. 2 is a diagram of the cross section of a sign panel;

FIG. 3 is a diagram schematically illustrating a manner of interior lighting;

FIG. 4 is a diagram schematically illustrating a manner of retroreflection;

FIG. 5 is a diagram of the cross section of a sign panel according to a second embodiment;

FIG. 6 is a diagram of the case where the shape and size are different between a first colored display layer and a second colored display layer; and

FIG. 7 is a diagram of the case where the shape and size are different between a first colored display layer and a second colored display layer.

### DETAILED DESCRIPTION OF THE INVENTION

### (1) First Embodiment

A first embodiment preferred to the present invention will be described in detail with reference to the drawings.

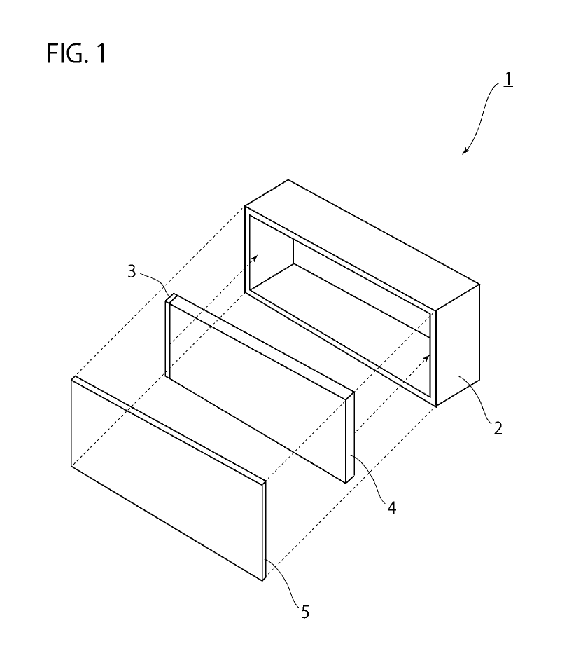

FIG. 1 is a diagram of an internally illuminated sign device 1 according to the first embodiment. As illustrated in FIG. 1, the internally illuminated sign device 1 according to the embodiment includes a housing 2, a lighting unit 3, a light guide plate 4, and a sign panel 5 as main components.

The housing 2 is a member that forms a space to accommodate the lighting unit 3. In FIG. 1, the housing 2 in a box shape including an opening in a rectangular parallelepiped shape. However, the housing 2 is an example, and the housing is not limited to the example. It is noted that preferably, the housing 2 is optically non-transparent.

The lighting unit 3 is a light source that applies light including white light, for example, and is disposed on the side face of the light guide plate 4 in the housing 2. A specific lighting unit 3 includes a line light source such as a cold cathode fluorescent lamp (CCFL) and a point light source such as a light emitting diode (LED) and a tungsten lamp, for example. It is noted that the drive period of the lighting unit 3 is defined as a period in the nighttime, for example.

The light guide plate 4 is a plate member that spreads light entered from the side face and emits uniform light from the front face, and is disposed on the rear side of the back face of the sign panel 5 in the housing 2.

The sign panel 5 is a sign panel that has the retroreflection characteristics with respect to light entered from the front face side of the sign panel 5, and has transparency with respect to light entered from the back face side of the sign panel 5.

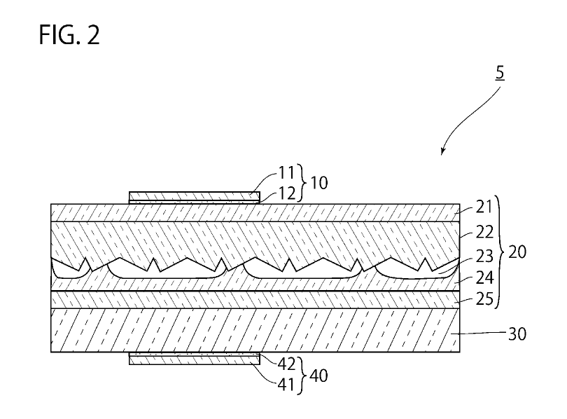

FIG. 2 is a diagram of the cross section of the sign panel 5. As illustrated in FIG. 2, the sign panel 5 includes a front side information display layer 10, a retroreflective layer 20, a reinforcement layer 30, and a rear side information display layer 40 as main components.

The front side information display layer 10 is a layer provided on the front side of the retroreflective layer 20, and is configured of a first colored display layer 11 and an adhesive layer 12 in the embodiment.

The first colored display layer 11 is a colored layer in a predetermined shape expressing information such as a character, a symbol, and a graphic form, and has optical transparency.

The thickness of the first colored display layer 11 is not limited specifically. However, the thickness of the first colored display layer 11 is preferably 0.5 to 10 μm, more preferably, 1 to 5 μm, and still more preferably, 2 to 4 μm. In the case where the thickness of the first colored display layer 11 is 0.5 μm or more, excellent formability is provided, and the hues are easily adjusted. Moreover, in the case where the thickness of the first colored display layer 11 is 10 μm or less, the adhesion strength with respect to the retroreflective layer 20 is not degraded.

Ink use for the first colored display layer 11 mainly includes a resin component and a coloring agent. In addition to this, one type or a plurality of types of additives such as a plasticizer, antifoamer, leveling agent, ultraviolet absorption agent, light stabilizer, heat stabilizer, and cross-linker may be included, as necessary. Furthermore, a solvent may be included for adjusting viscosity, for example.

The resin component of ink is not limited specifically. However, a melamine resin, epoxy resin, urethane resin, vinyl resin, polyester resin, and alkyd resin, for example, are preferable. This is because these resins are excellent in the dispersibility to coloring agents, stability, the solubility to solvents, weather-fastness, printing suitability, and adhesion to films, for example. It is noted that the resin component of ink may be one type of a resin or may be a copolymerization resin formed by combining two or more of types of resins.

The coloring agent for ink is not limited specifically. However, the coloring agent may be ones that can brighten hues, or may be fluorescent colors.

The adhesive layer 12 is a layer that attaches the first colored display layer 11 to a layer disposed on the frontmost side of the retroreflective layer 20, and has optical transparency. It is noted that in the case of the embodiment, the layer disposed on the frontmost side of the retroreflective layer 20 is a surface protective layer 21 described later.

A specific example of the adhesive layer 12 includes a pressure sensitive adhesive agent and a thermosensitive adhesive agent, for example. The pressure sensitive adhesive agent includes a silicon resin adhesive agent, a rubber adhesive agent, and a poly acrylic ester adhesive agent obtained by copolymerizing acrylic ester such as butylacrylate, 2-ethyl hexyl acrylate, isooctyl acrylate, and nonyl acrylate with acrylic acid or vinyl acetate, for example. The thermosensitive adhesive agent includes acrylics resins, polyester resins, and epoxy resins, for example.

The retroreflective layer 20 is configured of the surface protective layer 21, a prism layer 22, an air layer 23, a binder layer 24, and a support layer 25.

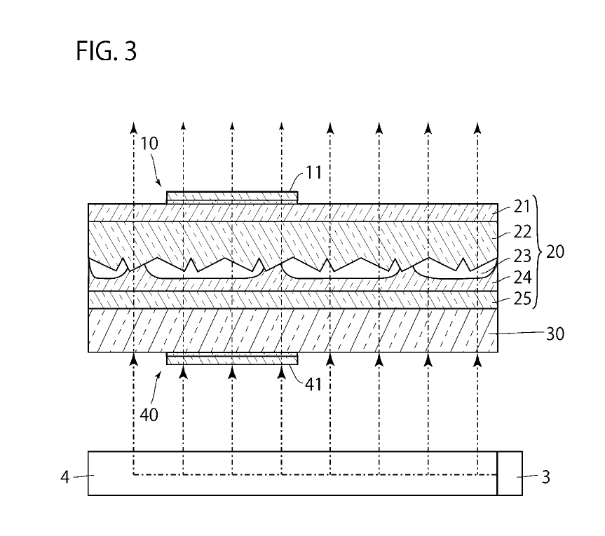

The surface protective layer 21 is a layer that protects the front face side of the sign panel 5 opposite to the back face side facing the light guide plate 4 (FIG. 3), and has optical transparency. The material of the surface protective layer 21 may be ones excellent in optical transparency or optical uniformity.

For example, the material of the surface protective layer 21 includes a polycarbonate resin, vinyl chloride resin, (meta) acrylic resin, epoxy resin, styrene resin, polyester resin, fluorine resin, polyethylene resin, olefin resin, cellulose resin, and urethane resin. Moreover, an ultraviolet absorption agent, a light stabilizer, and an antioxidant, for example, may be included in order to improve weather-fastness. Moreover, a coloring agent such as an organic pigment, inorganic pigment, fluorescent pigment, dyestuff, and fluorescent dyestuff may be included.

The prism layer 22 is a layer that retroreflects light entered from the front side of the sign panel 5 in the air layer 23 and is stacked on the back face of the surface protective layer 21. The prism layer 22 is not limited specifically as long as the prism layer 22 is one that retroreflects light in the interface on the air layer 23. However, it may be fine that the interface on the air layer 23 is in an irregular shape having regularity.

More specifically, the case is preferable where a polygonal pyramid retroreflective plane is provided in which a polyhedron such as a triangular pyramid and a hexagonal pyramid is disposed in a closest packed shape because excellent retroreflection characteristics are provided. It is noted that the prism layer 22 having this retroreflective plane is referred to as a cube corner reflective element, and is described in JP-A-2008-70898, for example.

The material of the prism layer 22 may be ones excellent in optical transparency or optical uniformity, including one similar to the material of the surface protective layer 21, for example.

The air layer 23 is a layer that increases a critical angle to satisfy the conditions for total internal reflection on the interface on the prism layer 22, and is formed on the interface on the binder layer 24 side (the back face side) of the prism layer 22.

The binder layer 24 is a layer that is bound to a part of the face of the prism layer 22 opposite to the face facing the surface protective layer 21 and forms the air layer 23 between the binder layer 24 and the portion other than the joining portion, and has optical transparency.

Preferably, the binder layer 24 is formed in an enclosing and sealing structure that prevents moisture from entering the air layer 23. This is because it is possible to suppress the degradation of the retroreflection performance of the interface between the prism layer 22 and the air layer 23 or the durability of the sign panel 5 caused by moisture that enters the air layer 23.

It is noted that a method for forming this enclosing and sealing structure is described in U.S. Pat. Nos. 3,190,178 and 4,025,159, and JP-U-50-28669, for example.

The material of the binder layer 24 includes a (meta) acrylic resin, polyester resin, alkyd resin, and epoxy resin, for example.

The support layer 25 is a layer that supports the binder layer 24, and has optical transparency. The support layer 25 is stacked on the back face of the binder layer 24 opposite to the front face facing the prism layer 22.

It is noted that the binder layer 24 may be disposed throughout one face of the support layer 25, and the binder layer 24 may be disposed on a part of the one face. Moreover, in the case of the embodiment, the support layer 25 is colored in a color different from colors applied to the first colored display layer 11 and a second colored display layer 41. It is noted that more preferably, the color applied to the support layer 25 is different in such a manner that the color difference can be visually recognized from the colors applied to the first colored display layer 11 and the second colored display layer 41. Furthermore, more preferably, the colors applied to the first colored display layer 11 and the second colored display layer 41 are a color at a diametrically opposed location in a color wheel, colors around the color, or a color whose light absorption is smaller than the light absorption of the colored display layer.

The material of the support layer 25 includes a resin similar to the material of the surface protective layer 21, a typical resin that can form films, fiber, cloth, metal such as aluminum nitride, and a composite material of these, for example. It is noted that in the case of using a material that does not have optical transparency, it may be fine that the material is formed in a mesh form to obtain an optically transparent support layer 25.

The reinforcement layer 30 is a layer that reinforces the sign panel 5 and has optical transparency. The reinforcement layer 30 is stacked on the face of the support layer 25 opposite to the face facing the binder layer 24. The material of the reinforcement layer 30 includes an acrylic resin, vinyl chloride resin, styrene resin, carbonate resin, and polyethylene terephthalate, for example.

The rear side information display layer 40 is a layer provided on the rear side of the retroreflective layer 20, and is configured of the second colored display layer 41 and an adhesive layer 42 in the embodiment.

The second colored display layer 41 is a colored layer that express information similar to information expressed on the first colored display layer 11, and has optical transparency. In the case of the embodiment, the second colored display layer 41 has the shape and size matched with the shape and size of the first colored display layer 11.

Moreover, the second colored display layer 41 is disposed at a position laid over the first colored display layer 11 in the case where the sign panel 5 is seen in front.

The thickness of the second colored display layer 41 is not limited specifically. However, the thickness of the second colored display layer 41 is preferably 0.5 to 10 μm, more preferably 1 to 5 μm, and still more preferably, 2 to 4 μm. In the case where the thickness of the first colored display layer 11 is 0.5 μm or more, excellent formability is provided, and the hues are easily adjusted. Moreover, in the case where the thickness of the first colored display layer 11 is 10 μm or less, the adhesion strength with respect to the retroreflective layer 20 is not degraded.

The ink used for the second colored display layer 41 mainly includes a resin component and a coloring agent similarly to the first colored display layer 11. In addition to this, one type or a plurality of types of additives such as a plasticizer, antifoamer, leveling agent, ultraviolet absorption agent, light stabilizer, heat stabilizer, and cross-linker may be included, as necessary. Furthermore, a solvent may be included for adjusting viscosity, for example.

A resin component of the ink is not limited specifically. However, a resin component similar to the resin component for the first colored display layer 11 is included. In addition, the coloring agent for the ink may be the same as one for the first colored display layer 11 or may be different one. In the case of the embodiment, colors are applied to the first colored display layer 11 and the second colored display layer 41 in the same hues.

The adhesive layer 42 is not limited specifically as long as an optically transparent one that attaches the second colored display layer 41 to the layer on the rearmost side of the retroreflective layer 20. However, for example, the adhesive layer 42 includes a pressure sensitive adhesive, a thermosensitive adhesive agent, etc. It is noted that in the case of the embodiment, it is the support layer 25 that is located on the rearmost side of the retroreflective layer 20.

FIG. 3 is a diagram schematically illustrating a manner of interior lighting. As illustrated in FIG. 3, light applied from the lighting unit 3 is entered from the side face of the light guide plate 4, and is emitted from the light emitting face of the light guide plate 4 opposite to the back face of the sign panel 5.

Moreover, light emitted from the light emitting face of the light guide plate 4 is entered from the back face of the sign panel 5, and transmitted through the layers of the sign panel 5.

At this time, the amount of light transmitted in turn through the rear side information display layer 40, the reinforcement layer 30, the retroreflective layer 20, and the front side information display layer 10 of the sign panel 5 is smaller than the amount of light transmitted only through the reinforcement layer 30 and the retroreflective layer 20.

Therefore, the contrast ratio of the information display portion expressed on the second colored display layer 41 of the rear side information display layer 40 and the first colored display layer 11 of the front side information display layer 10 to the portions other than the information display portion is increased. Thus, the visibility of the sign is improved even in the case where the outside of the housing 2 is dark and light is applied from the inside to the sign panel 5 as in the nighttime, for example.

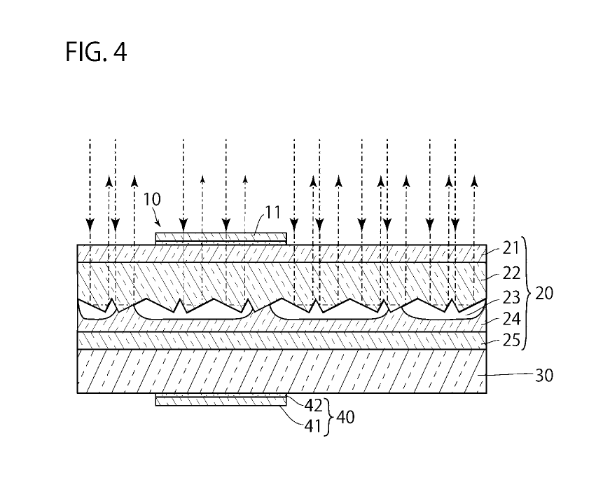

FIG. 4 is a diagram schematically illustrating a manner of retroreflection. As illustrated in FIG. 4, light entered from the outside of the housing 2 to the front face of the sign panel 5 is transmitted through the surface protective layer 21 of the retroreflective layer 20 of the sign panel 5, and is retroreflected in the interface between the prism layer 22 and the air layer 23 of the retroreflective layer 20. The retroreflected light is then emitted from the front face of the sign panel 5 only through the retroreflective layer 20 and the front side information display layer 10, or only through the retroreflective layer 20.

At this time, there is little light that is advanced in the air layer 23 of the retroreflective layer 20, reflected on the rear side of the rear side information display layer 40, transmitted through the rear side information display layer 40, and emitted from the front face of the sign panel 5.

Therefore, even though both of the second colored display layer 41 of the rear side information display layer 40 and the first colored display layer 11 of the front side information display layer 10 are disposed, it is possible to suppress the degradation of the retroreflection performance of the information display portion. Thus, the retroreflection performance is not degraded, so that a functionally useful sign can be provided in an emergency in which light is not enabled to be applied from the inside in the nighttime.

As described above, the sign panel 5 according to the embodiment includes the optically transparent first colored display layer 11 that expresses information such as a character, a symbol, and a graphic form as well as includes the optically transparent second colored display layer 41 that expresses information display similarly to the information display of the first colored display layer 11.

The second colored display layer 41 is disposed at a position laid over the first colored display layer 11 in the case where the sign panel 5 is seen in front, and is disposed on the rear side opposite to the front side of the prism layer 22, in which the first colored display layer 11 is disposed.

According to the sign panel 5, as described above, a most part of retroreflected light is transmitted only through the first colored display layer 11, and interior luminous light is transmitted through both of the first colored display layer 11 and the second colored display layer 41. Thus, the visibility can be improved in the case where light is applied using the lighting unit 3 internally provided in the nighttime without the degradation of the retroreflection performance of the colored display layer portion.

Meanwhile, in the case of the embodiment, the first colored display layer 11 and the second colored display layer 41 are colored in a same hue.

Therefore, the hues of the sign panel 5 in the daytime can be made the same as the hues of the sign panel in the nighttime. Accordingly, it is possible to improve the visibility of the sign illuminated with interior luminous light in the nighttime as the hues of the recognized sign are kept the same between the daytime and the nighttime.

### (2) Second Embodiment

A second embodiment preferred to the present invention will be described in detail with reference to the drawings. However, the components of an internally illuminated sign device according to the second embodiment that are the same or equivalent to the components of the first embodiment are designated the same reference numerals and signs, and the overlapping description is appropriately omitted.

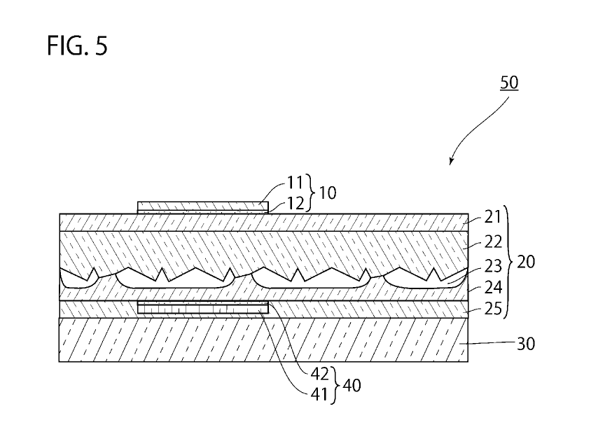

FIG. 5 is a diagram of the cross section of a sign panel according to the second embodiment. As illustrated in FIG. 5, the internally illuminated sign device according to the embodiment is different from the sign panel 5 according to the first embodiment in the position at which the rear side information display layer 40 is disposed.

That is, in the sign panel 5 according to the first embodiment, the rear side information display layer 40 on the reinforcement layer 30 is stacked on the face opposite to the face facing the retroreflective layer 20.

On the contrary, in a sign panel 50 according to the embodiment, a rear side information display layer 40 on a support layer 25 disposed on the rearmost side of a retroreflective layer 20 is stacked on the face opposite to the face facing a binder layer 24.

In the case where the rear side information display layer 40 is disposed in this manner, a second colored display layer 41 of the rear side information display layer 40 comes closer to a first colored display layer 11, as compared with the case of the first embodiment.

Therefore, the amount of light that spreads in the second colored display layer 41 and goes to avoid the first colored display layer 11 can be reduced by the amount that the second colored display layer 41 comes close to the first colored display layer 11. As a result, the information display portion expressed on the colored display layer can be clearly and visually recognized.

Moreover, in the sign panel 50 according to the embodiment, no color is applied to the support layer 25 of the retroreflective layer 20, and a color different from the colors applied to the first colored display layer 11 and the second colored display layer 41 is applied to the reinforcement layer 30.

As described above, a layer disposed between the first colored display layer 11 and the second colored display layer 41 is not colored, so that the hues and lightness of the information display portion expressed on the colored display layer can be easily controlled by interior luminous light, as compared with the case where a layer disposed between the first colored display layer 11 and the second colored display layer 41 is colored.

It is noted that more preferably, a color applied to the reinforcement layer 30 is different to the extent that the color difference can be visually recognized from the colors applied to the first colored display layer 11 and the second colored display layer 41, similarly to the case of the first embodiment. Moreover, more preferably, the colors applied to the first colored display layer 11 and the second colored display layer 41 are colors at diametrically opposed locations in a color wheel or colors around the colors, or colors whose light absorption is smaller than the light absorption of the colored display layer.

### (3) Other Embodiments

As described above, the embodiment is described as an example. However, the present invention is not limited to the embodiment.

For example, in the foregoing embodiment, the shape and size of the second colored display layer 41 are matched with the shape and size of the first colored display layer 11. However, it may be fine that the shape and size of the second colored display layer 41 are not matched with the shape and size of the first colored display layer 11 as long as the second colored display layer 41 is disposed at a position laid over the first colored display layer 11 in the case where the sign panel 5 is seen in front.

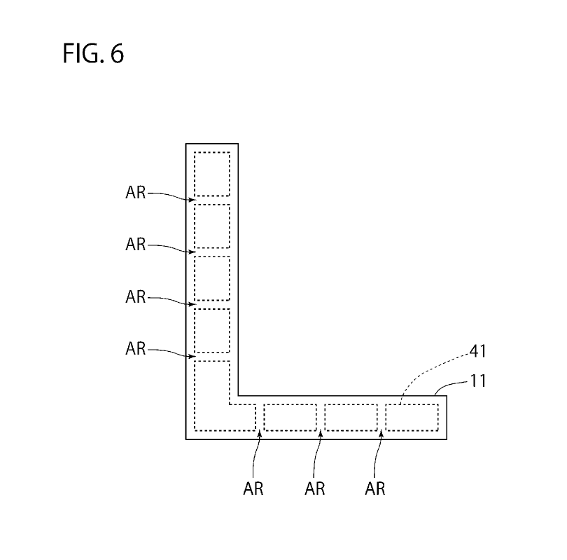

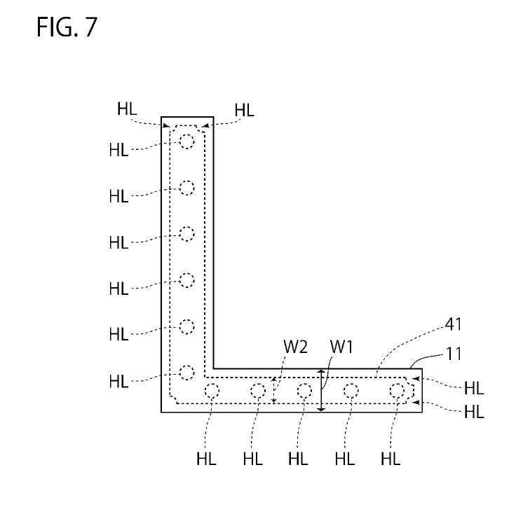

For example, as illustrated in FIG. 6, it may be fine that in the case where the second colored display layer 41 has the shape that can be considered to be the same as the shape of the first colored display layer 11, interruption areas AR are provided in the second colored display layer 41 and a part of the sign expressed by the second colored display layer 41 is interrupted. Moreover, as illustrated in FIG. 7, a hole HL may be formed in the inside or the peripheral region of the second colored display layer 41, for example.

It is noted that in FIGS. 6 and 7, the character “L”is illustrated as a sign expressed by the first colored display layer 11 and the second colored display layer 41 in the case where the sign panel 5 is seen from the front face side. However, the character may be a character other than the character. Furthermore, the character may be a symbol or a graphic form, for example, or may be a combination of a character and a symbol or a character and a graphic form, for example.

For another example, in the case where the second colored display layer 41 has the size to the extent that the size can be considered to be the same size as the size of the first colored display layer 11, the size of the second colored display layer 41 may be grater or smaller than the size of the first colored display layer 11.

However, in the case where the size of the second colored display layer 41 is smaller than the size of the first colored display layer 11, the amount of light that spreads in the second colored display layer 41 and goes to avoid the first colored display layer 11 can be reduced. Therefore, from the viewpoint of clearly and visually recognizing the information display portion expressed on the colored display layer, preferably, the size of the second colored display layer 41 is smaller than the size of the first colored display layer 11. More specifically, as illustrated in FIG. 7, there is the case where a width W2 of the second colored display layer 41 is smaller than a width W1 of the first colored display layer 11, for example.

In short, it may be fine that information display expressed on the second colored display layer 41 is almost the same as information display expressed on the first colored display layer 11.

In the foregoing embodiment, in the case where the sign panel 5 is seen in front, the second colored display layer 41 is disposed at a position at which the second colored display layer 41 is completely laid over the first colored display layer 11.

However, the second colored display layer 41 may be disposed at a position at which the second colored display layer 41 is overlapped with a part of the first colored display layer 11. For example, it may be fine that in the case where the size and shape of the second colored display layer 41 are almost the same as the size and shape of the first colored display layer 11 and the sign panel 5 is seen in front, the second colored display layer 41 is disposed at a position displaced from the first colored display layer 11.

That is, it may be fine that the first colored display layer 11 is disposed in such a manner that 50% or more of the size (area) is overlapped. In other words, it may be fine that the second colored display layer 41 is not completely laid over the first colored display layer 11 as long as the region of the second colored display layer 41 overlapped with the first colored display layer 11 is greater than the region not overlapped with the first colored display layer 11 in the case where the sign panel 5 is seen in front.

However, it is more preferable that the region of the second colored display layer 41 overlapped with the first colored display layer 11 be much greater than the region not overlapped with the first colored display layer 11 in the case where the sign panel 5 is seen in front.

Moreover, in the foregoing embodiment, the first colored display layer 11 and the second colored display layer 41 are colored in a same hues. However, the hues of the second colored display layer 41 may be adjusted as matched with the color temperature of interior luminous light. For example, it may be also possible that in the case where an yellowish light source is used for interior luminous light, the yellowishness of the hues of the second colored display layer is reduced for adjustment in such a manner that the hues of the information display portion do not go to excessively yellowish caused by interior luminous light.

That is, it may be fine that colors are applied to the first colored display layer 11 and the second colored display layer 41 so as not to have the completely same hues. However, preferably, the first colored display layer 11 and the second colored display layer 41 are colored in almost the same hue.

Furthermore, in the foregoing embodiment, the relationship between the amount of light transmission in the first colored display layer 11 and the amount of light transmission in the second colored display layer 41 is not described specifically. However, preferably, the amount of light transmission in the first colored display layer 11 is greater than the amount of light transmission in the second colored display layer 41.

In the case where this relationship is provided, the amount of light transmitted through the first colored display layer 11 is hardly reduced, as compared with the case where the amount of light transmission in the first colored display layer 11 is equal to or smaller than the amount of light transmission in the second colored display layer 41, so that it is possible to improve the retroreflection performance of the colored display layer portion. Accordingly, it is possible to further improve the visibility of the sign also illumined with retroreflected light in an emergency in the nighttime as described above.

In addition, in the foregoing embodiment, the second colored display layer 41 is bound to one face of the reinforcement layer 30 or the retroreflective layer 20 with the adhesive layer 42. However, it may be fine that the second colored display layer 41 is bound to one face of the layer on which the second colored display layer 41 is to be stacked by surface tension, for example, between the second colored display layer 41 and the layer on which the second colored display layer 41 is to be stacked.

In the case where this configuration is provided, the adhesive layer 12 or 42 can be omitted, so that the thickness of the sign panel can be reduced, as compared with the case where the second colored display layer 41 is bound using the adhesive layer 12 or 42. It is noted that in the case where the adhesive layer 12 or 42 is omitted, the first colored display layer 11 or the second colored display layer 41 can be formed by gravure printing, screen printing, or ink jet printing, for example.

In the foregoing embodiment, the retroreflective layer 20 is configured of the surface protective layer 21, the prism layer 22, the air layer 23, the binder layer 24, and the support layer 25. However, the components of the retroreflective layer are not limited to the foregoing embodiment as long as the retroreflective layer has the retroreflection characteristics with respect to light entered from the front face side and has transparency with respect to light entered from the back face side. For example, it is also possible to omit the surface protective layer 21 and to additionally provide a layer other than the layers configuring the retroreflective layer 20 according to the embodiment. It is noted that the reinforcement layer 30 of the sign panel 5 or 50 may be omitted. Moreover, it may be fine that a transparent film is applied to cover the first colored display layer 11 disposed on the front face of the sign panel 5.

In the foregoing embodiment, light applied from the lighting unit 3 is applied to the back face of the sign panel 5 or 50 through the light guide plate 4. However, the light guide plate 4 may be omitted when light is applied to the back face of the sign panel 5 or 50. For example, in the case where a plurality of LEDs is provided in a lattice on the inner bottom face, for example, of the housing 2, light can be uniformly applied to the back face of the sign panel 5 or 50 even though the light guide plate 4 is not provided.

1. An internally illuminated sign device comprising:
a sign panel; and
a lighting unit configured to apply light from a rear side of the sign panel to the sign panel, wherein
the sign panel includes
a prism layer,
an air layer disposed on an interface on a rear side of the prism layer,
a first colored display layer of optical transparency disposed on a front side of the prism layer, the first colored display layer having a predetermined shape,
a second colored display layer of optical transparency disposed on a rear side of the air layer, the second colored display layer having a shape visible similarly to the first colored display layer, and
the second colored display layer is disposed at a position at which the second colored display layer is overlapped with the first colored display layer when the sign panel is seen in front.

2. The internally illuminated sign device according to claim 1, wherein an amount of light transmission in the first colored display layer is greater than an amount of light transmission in the second colored display layer.

3. The internally illuminated sign device according to, claim 3 wherein a size of the second colored display layer is smaller than a size of the first colored display layer when the sign panel is seen in the front.

4. The internally illuminated sign device according to claim 1, wherein a layer disposed between the first colored display layer and the second colored display layer is not colored.

5. The internally illuminated sign device according to claim 1, wherein the first colored display layer and the second colored display layer are colored in a same hue.

6. The internally illuminated sign device according to claim 2, wherein a size of the second colored display layer is smaller than a size of the first colored display layer when the sign panel is seen in the front.
